(19) United States
(12) Patent Application Publication
(10) Pub. No.: US 2018/0138003 A1
(43) Pub. Date: May 17, 2018

(54) STRAIN-RELIEVED FUSE AND METHOD OF FORMING A STRAIN-RELIEVED FUSE

(71) Applicant: Littelfuse, Inc., Chicago, IL (US)

(72) Inventors: Michael Schlaak, Morton Grove, IL (US); Julio Urrea, Lombard, IL (US)

(73) Assignee: Littelfuse, Inc., Chicago, IL (US)

(21) Appl. No.: 15/349,160

(22) Filed: Nov. 11, 2016

(51) Int. Cl. H01H 85/00; H01H 85/055; H01H 69/02; H01H 85/143

(52) U.S. Cl. CPC H01H 85/0013; H01H 85/055; H01H 2239/072; H01H 85/143; H01H 69/02

(57) ABSTRACT

A fuse including a fuse body, a fuse element including a first terminal end extending from a first end of the fuse body, and a second terminal extending from a second end of the fuse body, wherein at least one of the first terminal end and the second terminal end extending out of the respective first and second ends of the fuse body include a strain relief feature, and wherein the strain relief feature is configured to flex in response to thermal fluctuation of the fuse or the surrounding components to which it is attached.

### FIELD OF THE DISCLOSURE

Embodiments of the present disclosure relate generally to the field of fuses, and more particularly to a fuse including a strain-relieved terminal.

### BACKGROUND OF THE DISCLOSURE

Fuses are used as circuit protection devices and form electrical connections with components in circuits to be protected. One type of fuse includes a fusible element that is disposed within a hollow fuse body and that extends between a pair of terminals. The terminals may be rigidly secured or fastened to other circuit components by bolts or other fasteners, which are mounted inside a plastic fuse box and constrain the fuse. In operation, the system may fluctuate in temperature, whereby the fuse box and components of the fuse may expand and/or contract. Since the fuse box and various components of the fuse are formed of different materials, the components may expand and contract at different rates and to different degrees due to differences in the coefficients of thermal expansion (CTE) of the materials, resulting in relative movement between the components. Since the fuse terminals are rigidly fixed in place within the fuse box, the components of the fuse may be pushed toward and/or pulled away from the terminals during expansion and contraction, subjecting the components to mechanical stress which may, in some cases, crack or otherwise damage the components.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In an embodiment of the present disclosure, a fuse includes a fuse body, a fuse element including a first terminal end extending from a first end of the fuse body, and a second terminal extending from a second end of the fuse body, wherein at least one of the first terminal end and the second terminal end extending out of the respective first and second ends of the fuse body include a strain relief feature, and wherein the strain relief feature is configured to flex in response to thermal fluctuation of the fuse.

In an embodiment, a method for forming a fuse includes joining a first terminal end and a second terminal end to opposing ends of a fuse element, inserting the fuse element into a fuse body, the first terminal end extending out of a first end of the fuse body, and the second terminal end extending out of a second end of the fuse body, mounting apertures being formed in the first and second terminal ends, joining end caps to the first and second ends of the fuse body, the first and second terminal ends extending through the end caps, and forming a strain relief feature in at least one of the first terminal end and the second terminal end, the strain relief feature being disposed intermediate a respective one of the mounting apertures and end caps, wherein the strain relief feature is configured to flex in response to thermal fluctuation of the fuse.

### BRIEF DESCRIPTION OF THE DRAWINGS

By way of example, specific embodiments of the disclosed device will now be described with reference to the accompanying drawings, in which:

FIGS. 1A-1B illustrate a perspective view and a side view, respectively, of an exemplary fuse according to embodiments of the present disclosure;

FIGS. 2A-2B illustrate a perspective view and a side view, respectively, of an exemplary fuse according to embodiments of the present disclosure;

FIGS. 3A-3B illustrate a perspective view and a side view, respectively, of an exemplary fuse according to embodiments of the present disclosure;

FIGS. 4A-4B illustrate a perspective view and a side view, respectively, of an exemplary fuse according to embodiments of the present disclosure;

FIGS. 5A-5B illustrate a perspective view and a side view, respectively, of an exemplary fuse according to embodiments of the present disclosure;

FIGS. 6A-6B illustrate a perspective view and a side view, respectively, of an exemplary fuse according to embodiments of the present disclosure;

FIGS. 7A-7B illustrate a perspective view and a side view, respectively, of an exemplary fuse according to embodiments of the present disclosure;

FIGS. 8A-8B illustrate perspective views of a portion of an exemplary fuse according to embodiments of the present disclosure;

FIG. 9 is a flow diagram of a method of forming a fuse according to the present disclosure.

### DETAILED DESCRIPTION

A fuse in accordance with the present disclosure will now be described more fully hereinafter with reference to the accompanying drawings, in which certain exemplary embodiments of the fuse are presented. The fuse may be embodied in many different forms and is not to be construed as being limited to the embodiments set forth herein. These embodiments are provided so that this disclosure will be thorough and complete, and will fully convey the scope of the fuse to those skilled in the art. In the drawings, like numbers refer to like elements throughout unless otherwise noted.

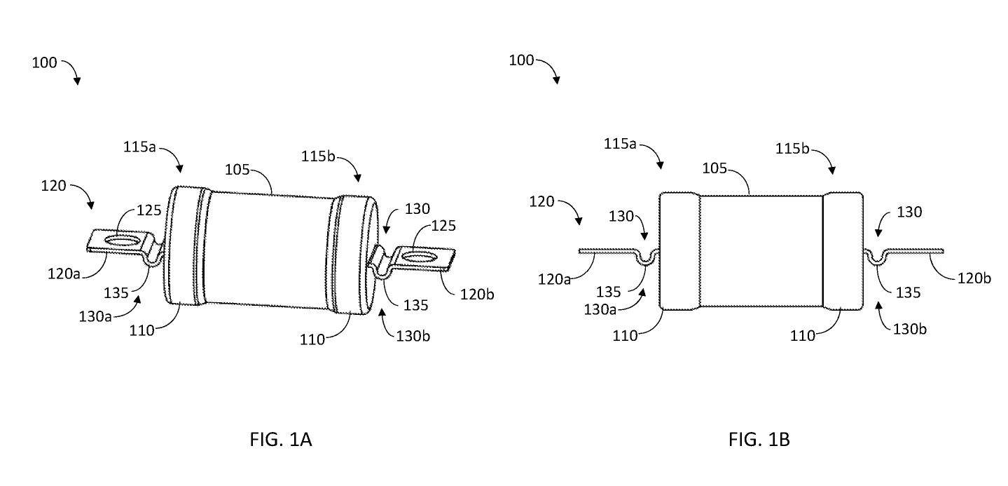

Referring to FIGS. 1A and 1B, a non-limiting, exemplary embodiment of a fuse 100 in accordance with the present disclosure is shown. The fuse 100 may include a fuse element 120 disposed in a cavity of a fuse body 105 and having first and second terminal ends 120a, 120b extending outside of the fuse body 105. The first terminal end 120a and the second terminal end 120b may extend through end caps 110 that fit over the ends 115a, 115b of the fuse body 105 and may each include a mounting aperture 125 for receiving a bolt or other fastener to secure the fuse 100 to other circuit components (not shown). The remaining open volume in the cavity of the fuse body 105 may be filled with an arc-quenching material, such as silica sand (not shown). The end caps 110 may be coupled to the ends 115a, 115b of the fuse body 105 using any conventional means of attachment, including, but not limited to, solder, various adhesives, and/or various means of mechanical attachment, such as press fitting.

The fuse element 120 may be formed of an electrically conductive material, including, but not limited to, silver or copper, and may be configured to melt or otherwise separate upon the occurrence of a predetermined fault condition, such as an overcurrent condition in which an amount of current exceeding a predefined maximum current flows through the fuse element 120. The fuse element 120, which is depicted generically in FIGS. 1A and 1B, may be any type of fusible element suitable for a desired application, including, but not limited to, a fuse wire, a corrugated strip, a fuse wire wound about an insulating core, etc. In some embodiments, the fuse element 120 may extend diagonally through the hollow interior of the fuse body 105. In an embodiment, the fuse element 120 and the terminal ends 120a, 120b may be a one-piece configuration. In some embodiments, the fuse element 120 and the terminal ends 120a, 120b may be a multi-piece construction, and may be joined by any conventional, electrically conductive means of attachment, including, but not limited to, soldering, welding, brazing, and the like.

In operation, the terminal ends 120a, 120b of the fuse 100 may be rigidly fastened to other circuit elements (not shown) by bolts or other fasteners. As electrical current passes through the fuse 100, the components of the fuse 100 (e.g., the fuse element 120, the end caps 110, and the fuse body 105) may be subjected to thermal fluctuations and may therefore experience thermal expansion and contraction. Since the components of the fuse 100 are formed of different materials, the components may expand and contract at different rates and to different degrees due to differences in the coefficients of thermal expansion (CTE) of the materials, resulting in relative movement between the components. Often, the fuse may be mounted in a fuse box that is made from a material with a relatively high CTE in comparison to the fuse components. Since the terminal ends 120a, 120b are rigidly fixed in place, the components of the fuse 100 may be pushed toward and/or pulled away from the terminal ends 120a, 120b during expansion and contraction of the components or fuse box, subjecting the components to mechanical stress which may result in damage to the components. The fuse element 120, which is typically very thin and/or delicate, may be particularly susceptible to premature breakage from such mechanical stress.

Still referring to FIGS. 1A and 1B, the terminal ends 120a, 120b may include respective strain relief features 130a, 130b formed therein. The strain relief features 130a, 130b may be located intermediate the end caps 110 and the mounting apertures 125 of the terminal ends 120a, 120b and may advantageously permit the terminal ends 120a, 120b to flex in response to expansion and contraction of the fuse box or components of the fuse 100 (as further described below) to prevent or mitigate damage that may otherwise result from mechanical stress on such components.

The strain relief features 130a, 130b may each include one or more crimps, bends, folds, channels, corrugations, or the like formed in the terminal ends 120a, 120b that permit the terminal ends 120a, 120b to extend and retract in a spring-like manner in response to mechanical force applied thereto. The strain relief features 130a, 130b may be configured to flex in response to mechanical strain, typically induced by thermal fluctuation of the fuse or surrounding components to which the fuse is connected (e.g., a plastic fuse box). Thus, the strain relief features 130a, 130b may act as dampers that accommodate expansion and contraction of the fuse box and various components of the fuse 100 to prevent such expansion and contraction from placing mechanical stress on components of the fuse 100 that are susceptible to breakage. For example, if the fuse body 105 of the fuse 100 were to undergo thermal contraction, the fuse body 105 would pull inwardly on the terminal ends 120a, 120b. This pulling would cause the strain relief features 130a, 130b to flex and extend in an accordion-like manner inwardly, toward the fuse element 120, mitigating tensile strain in the relatively fragile internal features of the fuse element 120 and preventing the fuse element 120 from breaking. In the absence of the strain relief features 130a, 130b (i.e., in conventional fuses), the accumulation of tensile strain in the fuse element 120 would go unmitigated and the fuse element 120 may therefore break.

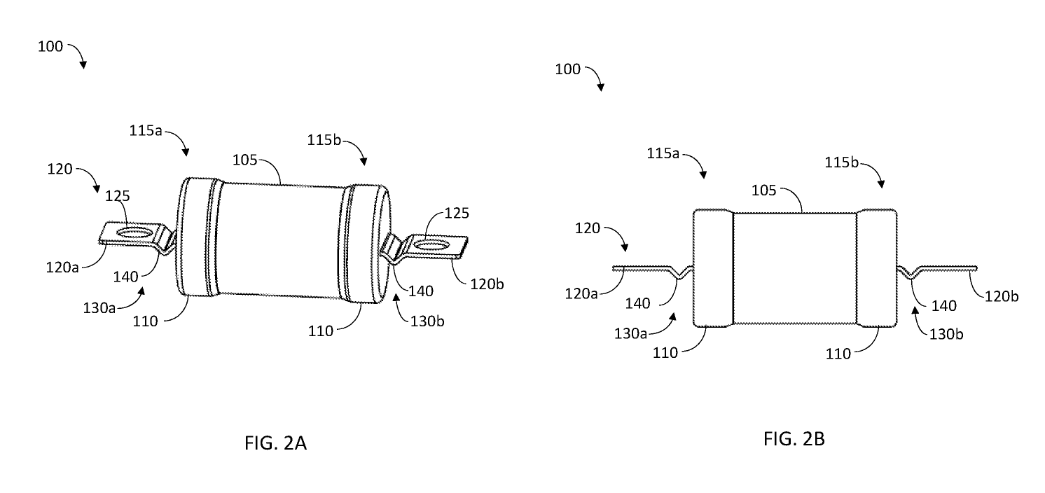

In various embodiments of the fuse 100 the strain relief features 130a, 130b may include channels or corrugations having different shapes and/or configurations for providing the terminals ends 120a, 120b with greater or lesser flexibility as desired. For example, referring to the embodiments of the fuse 100 shown in FIGS. 1A, 1B, 6A, 6B, 7A, 7B, the strain relief features 130a, 130b are defined by u-shaped channels 135. Referring to the embodiments of the fuse 100 shown in FIGS. 2A, 2B, the strain relief features 130a, 130b are defined by v-shaped channels 140. Although the channels are shown in a vertically downward orientation relative to the fuse 100, it should be understood that the channels may alternatively be oriented in a vertically upward orientation. In various embodiments, the strain relief features 130a, 130b may be defined by any types of crimps, bends, folds, channels, corrugations, or the like formed in the terminal ends 120a, 120b that permit flexure in the manner described above.

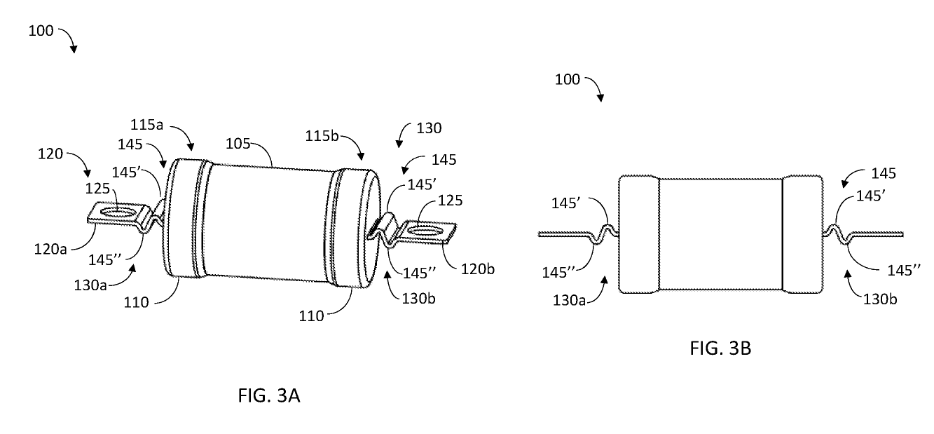

In an embodiment, one or both of the strain relief features 130a, 130b may include a single corrugation, and in other embodiments one or both of the strain relief features 130a, 130b may include a plurality of corrugations 145. In an embodiment, the plurality of corrugations 145 may be alternating. The strain relief features 130a, 130b may each include a ridge 145′ and a groove 145″ as shown in FIGS. 3A, 3B. The ridges 145′ may be oriented vertically upward relative to the fuse 100 and the grooves 145″ may be oriented vertically downward relative to the fuse 100 to define an S-shaped contour. In an embodiment, the ridges 145′ may be disposed proximal to the end caps 110 and the grooves 145″ may be disposed distal from the end caps 110 as shown in FIGS. 3A, 3B. In another embodiment, the grooves 145″ may be disposed proximal to the end caps 110 and the ridges 145′ may be disposed distal from the end caps 110.

In various embodiments of the fuse 100, the strain relief features 130a, 130b may be identical to one another or may be different from one another. For example, FIGS. 1A-2B illustrate a first strain relief feature 130a defined by channels 135 (see FIGS. 2A, 2B) and 140 (see FIGS. 2A, 2B) in the first terminal end 120a that are substantially identical to the channels 135, 140 that define the second strain relief feature 130b in the second terminal end 120b. In various embodiments, the strain relief features 130a, 130b may be mirror images of each other, such as, for example, the corrugations 145 shown in FIGS. 3A, 3B.

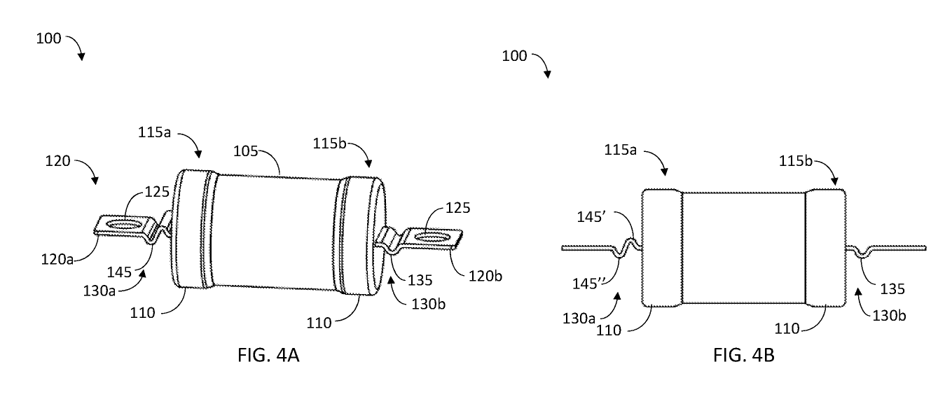

Referring now to FIGS. 4A, 4B, the fuse element 120 may include a first strain relief feature 130a that is different from a second strain relief feature 130b. The fuse 100 may include any combination of one or more crimps, bends, folds, channels, corrugations, or the like. In an embodiment, one of the terminal ends 120a may include the strain relief feature 130a having one or more crimps, bends, folds, channels, corrugations, or the like, e.g., a channel 135, 140, or plurality of corrugations 145. The other of the terminal ends 120b may include the strain relief feature 130b having another one or more crimps, bends, folds, channels, corrugations, or the like, e.g., a channel 135, 140, or plurality of corrugations 145, that is different from the first strain relief feature 130a. For example, FIGS. 4A, 4B illustrate a first strain relief feature 130a at the first terminal end 120a that includes a plurality of corrugations 145 including ridges 145′ and grooves 145″. The second strain relief feature 130b at the second terminal end 120b may be defined by a c-shaped or u-shaped channel 135.

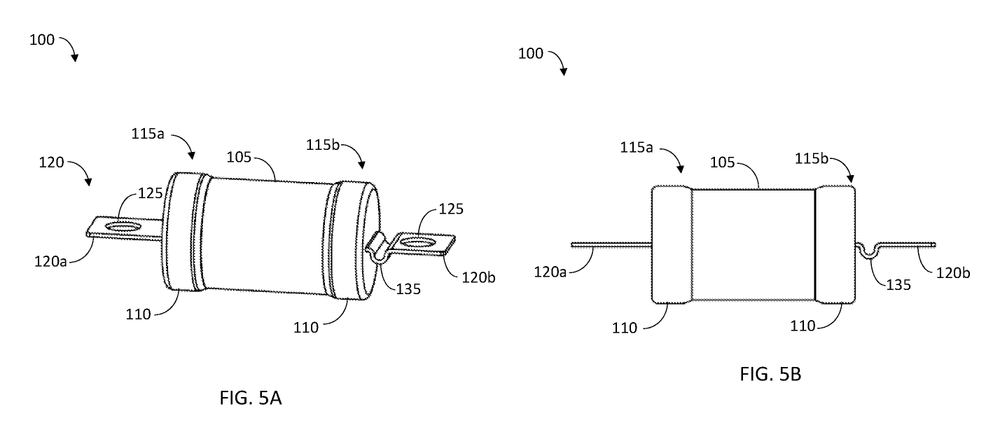

In an embodiment, a strain relief feature 130a, 130b may be disposed at one of the terminal ends 120a, 120b, while the other of the terminal ends 120a, 120b does not include a strain relief feature. For example, FIGS. 5A, 5B shows a first terminal end 120a and a second terminal end 120b, wherein the first terminal 120a does not include a strain relief feature 130 and the second terminal 120b includes a strain relief feature 130b having defined by a c-shaped or u-shaped channel. It should be understood that the strain relief features 130a, 130b may include one or more crimps, bends, folds, channels, corrugations, or the like.

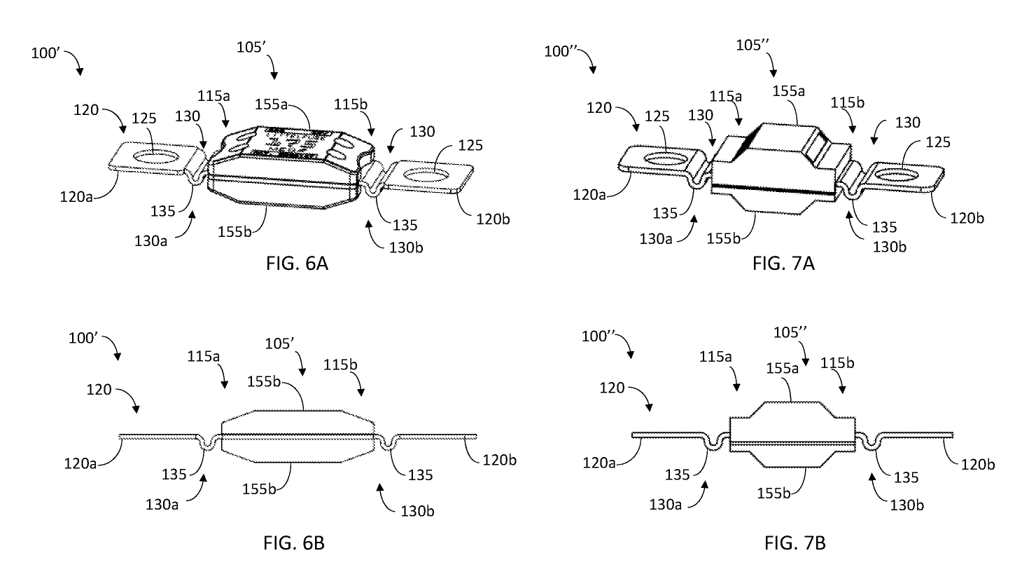

Any of the above-described strain relief features may be implemented in any of a variety of fuse types. For example, FIGS. 1A-5B illustrate cartridge fuses for high voltage, hybrid electric vehicle (HEV) applications, and FIGS. 6A-7B illustrate MIDI® and MEGA-type fuses. Although the strain relief features 130a, 130b are shown as being defined by a u-shaped or c-shaped channel 135, it should be understood that the fuses 100′, 100″ may include one or more crimps, bends, folds, channels, corrugations, or the like in strain relief features 130a, 130b, in any combination. A fuse body 105′, 105″ may enclose at least a portion of the fuse element 120. The fuse body 105′, 105″ may have one or more portions 155a, 155b that may be joined together using any conventional means of attachment, including, but not limited to, solder, various adhesives, and/or various means of mechanical attachment. The terminal ends 120a, 120b of the fuse element 120 may extend out of the ends of the fuse body 105′, 105″. For example, the first terminal end 120a may extend out of the first end 115a of the fuse body 105′, 105″, and the second terminal end 120b may extend out of the second end 115b of the fuse body 105′, 105″. The fuse body 105′, 105″ may have recesses at the first and second ends 115a, 115b so that the terminal ends 120a, 120b may extend beyond the fuse body 105′, 105″.

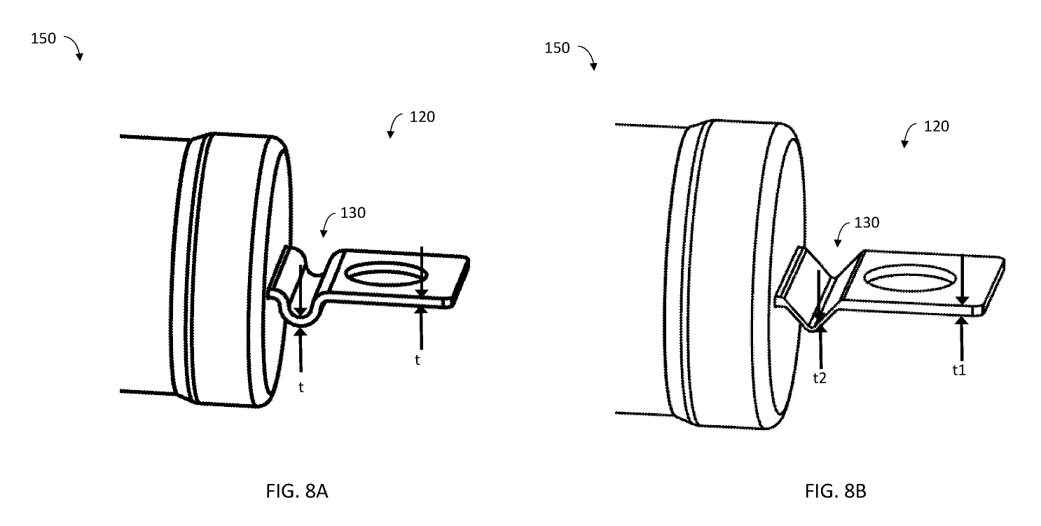

Referring now to FIGS. 8A, 8B, a portion 150 of fuse 100 is shown. In an embodiment, the fuse element 120 may have a thickness t, which may be constant through the terminal ends 120a, 120b. For example, the material thickness t of the strain relief feature 130a, 130b may be the same as the material thickness of the terminal ends 120a, 120b, as shown in FIG. 8A. Although a channel 135 is shown in FIG. 8A, it should be understood that any one or more of crimps, bends, folds, channels, corrugations, or the like may have a constant material thickness t as the terminal ends 120a, 120b.

In an embodiment, the material thickness of the fuse element 120 may be variable, as shown in FIG. 8B. For example, the terminal ends 120a, 120b may have a material thickness t1. If one of the strain relief features 130a, 130b is disposed in one of the terminal ends 120a, 120b, the strain relief feature 130a, 130b may have a material thickness t2, different from the material thickness t1. In an embodiment, the material thickness t2 of the strain relief feature 130a, 130b may be less than the material thickness t1 of the terminal end 120a, 120b. It may be advantageous to reduce a material thickness through the strain relief feature 130a, 130b to permit additional flexure in response to expansion and contraction of the components of the fuse 100. Although a channel 135 is shown in FIG. 8B, it should be understood that any of the channels 135, 140, or plurality of corrugations 145, including but not limited to one or more crimps, bends, folds, channels, corrugations, or the like, may have a variable material thickness from the terminal ends 120a, 120b.

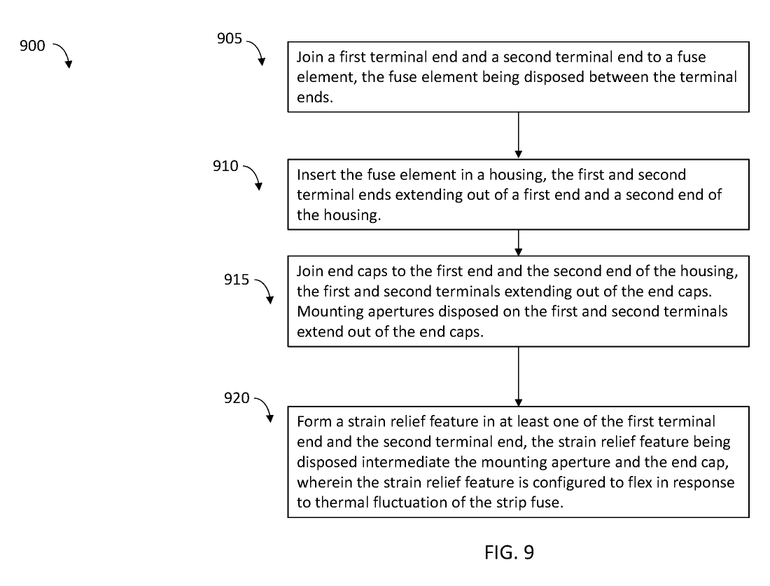

FIG. 9 illustrates a flow diagram 900 of a method of forming a fuse according to an embodiment of the present disclosure. At block 905, a first terminal end and a second terminal end are joined to opposing ends of a fuse element. For example, the first terminal end and a second terminal end may be joined the fuse element by any conventional, electrically conductive means of attachment, including, but not limited to, soldering, welding, brazing, and the like. In another embodiment, the terminal ends and the fuse element may be a single piece construction.

At block 910, the fuse element including the first and second terminal ends is inserted into a tubular fuse body with the first and second terminal ends protruding from opposing ends of the fuse body. In some embodiments, the fuse body may include at least two portions that are joined together to define an internal cavity.

At block 915, ends caps are joined to the first end and the second end of the fuse body. The first terminal end and the second terminal end may extend through apertures in the end caps. Mounting apertures for receiving a bolt or other fastener to secure the fuse to other circuit components may be formed in portions of the first and second terminal ends that protrude from the end caps.

At block 920, a strain relief feature is formed in at least one of the first terminal end and the second terminal end. As described above, the strain relief features may be located intermediate the end caps and the mounting apertures of the terminal ends to advantageously permit the terminal ends to flex in response to thermal fluctuation (e.g., expansion and contraction) of the components of the fuse to prevent or mitigate damage that may otherwise result from mechanical stress on such components. The strain relief features may include channels or corrugations having different shapes and/or configurations for providing the terminals ends with greater or lesser flexibility as desired.

It should be understood that the strain relief features may be formed at any of various stages of forming the fuse. Strain relief channels may include one or more crimps, bends, folds, channels, corrugations, or the like, which may act as dampers that accommodate expansion and contraction of the various components of the fuse to prevent such expansion and contraction from placing mechanical stress on components of the fuse that are susceptible to breakage. In an embodiment, the strain relief feature may be formed in the terminal ends when the fuse element and terminal ends are processed. For example, the strain relief features may be formed in the terminal ends prior to joining to the fuse element in block 905. In another embodiment, the strain relief features may be formed as a secondary operation to completed the completed fuses, e.g., after the terminal ends are joined to the fuse element in block 905.

As used herein, references to “an embodiment,” “an implementation,” “an example,” and/or equivalents is not intended to be interpreted as excluding the existence of additional embodiments also incorporating the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize its usefulness is not limited thereto and the present disclosure can be beneficially implemented in any number of environments for any number of purposes. Thus, the claims set forth below are to be construed in view of the full breadth and spirit of the present disclosure as described herein.

1. A fuse, comprising:
a fuse body;
a one-piece fuse element disposed through the fuse body including a first terminal end extending from a first end of the fuse body, and a second terminal end extending from a second end of the fuse body;
wherein at least one of the first terminal end and the second terminal end extending out of the respective first and second ends of the fuse body include a strain relief feature; and
wherein the strain relief feature is configured to flex in response to thermal fluctuation of the fuse or surrounding components to which the fuse is mounted.

2. The fuse according to claim 1, wherein the strain relief feature includes one or more crimps, bends, folds, channels, or corrugations.

3. The fuse according to claim 2, wherein the strain relief feature is defined by at least one of a c-shaped channel, a v-shaped channel, and a u-shaped channel.

4. The fuse according to claim 2, wherein the strain relief feature includes a plurality of corrugations.

5. The fuse according to claim 4, wherein the plurality of corrugations includes at least one of a c-shaped channel, a v-shaped channel, and a u-shaped channel.

6. The fuse according to claim 4, wherein the plurality of corrugations includes alternating ridges and grooves.

7. The fuse according to claim 1, wherein the first terminal end includes a first strain relief feature, and the second terminal end includes a second strain relief feature.

8. The fuse according to claim 7, wherein the first strain relief feature includes one or more crimps, bends, folds, channels, or corrugations, and the second strain relief feature includes one or more crimps, bends, folds, channels, and corrugations, the first and second strain relief features being identical.

9. The fuse according to claim 7, wherein the first strain relief feature includes one or more crimps, bends, folds, channels, or corrugations, and the second strain relief includes one or more crimps, bends, folds, channels, or corrugations, the first and second strain relief features being different from one another.

10. The fuse according to claim 7, wherein one of the first strain relief feature and the second strain relief feature includes one or more crimps, bends, folds, channels, or corrugations, and the other of the first strain relief feature and the second strain relief feature includes a plurality of corrugations.

11. (canceled)

12. The method according to claim 21, wherein the strain relief feature includes one or more crimps, bends, folds, channels, or corrugations.

13. The method according to claim 12, wherein the strain relief feature includes at least one of a c-shaped channel, a v-shaped channel, and a u-shaped channel.

14. The method according to claim 21, wherein the strain relief feature includes a plurality of corrugations.

15. The method according to claim 14, wherein the plurality of corrugations includes at least one of a c-shaped channel, a v-shaped channel, and a u-shaped channel.

16. The method according to claim 14, wherein the plurality of corrugations includes ridges and grooves.

17. The method according to claim 21, wherein the first terminal end includes a first strain relief feature, and the second terminal end includes a second strain relief feature.

18. The method according to claim 17, wherein the first strain relief feature includes one or more crimps, bends, folds, channels, or corrugations, and the second strain relief feature includes one or more crimps, bends, folds, channels, or corrugations, the first and second strain relief features being identical.

19. The method according to claim 17, wherein the first strain relief feature includes one or more crimps, bends, folds, channels, or corrugations, and the second strain relief includes one or more crimps, bends, folds, channels, or corrugations, the first and second strain relief features being different from one another.

20. The method according to claim 17, wherein one of the first strain relief feature and the second strain relief feature includes one or more crimps, bends, folds, channels, or corrugations, and the other of the first strain relief feature and the second strain relief feature includes a plurality of corrugations.

21. A method for forming a fuse, comprising:
inserting a one-piece fuse element having opposing terminal ends into a fuse body, a first terminal end extending out of a first end of the fuse body, and a second terminal end extending out of a second end of the fuse body, mounting apertures being formed in the first and second terminal ends;
joining end caps to the first and second ends of the fuse body, the first and second terminal ends extending through the end caps; and
forming a strain relief feature in at least one of the first terminal end and the second terminal end, the strain relief feature being disposed intermediate a respective one of the mounting apertures and end caps;
wherein the strain relief feature is configured to flex in response to thermal fluctuation of the fuse.
